(19) United States
(12) Patent Application Publication
(10) Pub. No.: US 2017/0018199 A1
(43) Pub. Date: Jan. 19, 2017

(54) WEARABLE DIET AND EXERCISE TRACKING DEVICE WITH ONE-SUBMISSION TRACKING

(71) Applicant: Genesant Technologies, Inc., Vienna, VA (US)

(72) Inventors: James J. Mrowka, San Mateo, CA (US); Athanasios G. Christ, Reston, VA (US)

(73) Assignee: Genesant Technologies, Inc., Vienna, VA (US)

(21) Appl. No.: 15/212,051

(22) Filed: Jul. 15, 2016

Related U.S. Application Data
(63) Continuation-in-part of application No. 15/161,588, filed on May 23, 2016.
Application No. 15/161,588 is a continuation-in-part of application No. 15/041,780, filed on Feb. 11, 2016, now Pat. No. 9,449,530.
(60) Provisional application No. 62/193,879, filed on Jul. 17, 2015.

(51) Int. Cl. G09B 5/00; G10L 15/26; G06F 17/27; G09B 19/00; A63B 24/00

(52) U.S. Cl. CPC G09B 5/00; G09B 19/0092; A63B 24/0062; G06F 17/2705; G06F 17/2765; G10L 15/26

(57) ABSTRACT

A wearable diet and exercise tracking device that provides one-submission input of foods eaten, quantities consumed, exercises performed and exercise quantities, the reporting of tracked information and comprehensive diet and exercise tracking directly via the device. Embodiment of the invention may be in the form of, or integrated with, wrist-secured bands, smartwatches, clothes and fitness gear attachable/embedded devices and other portable and/or wearable enclosures.

### CROSS-REFERENCE TO RELATED APPLICATIONS

This application is a continuation-in-part of prior U.S. application Ser. No. 15/161,588, filed 23 May 2016, which is a continuation-in-part of prior U.S. application Ser. No. 15/041,780, filed 11 Feb. 2016, and claims the benefit of U.S. Provisional Application No. 62/193,879, filed 17 Jul. 2015, the disclosures of which applications are incorporated by reference herein.

### BACKGROUND

Diet and exercise tracking, as used herein, refer to activities by which an individual records (tracks) data related to food consumption and physical activity. For example, an individual may track all the daily foods eaten, the food quantities and the related calorie and nutrient data when diet tracking, and may track all the exercises, exercise quantities and related calories burned data in a workout when exercise tracking.

Known diet and exercise tracking products include: i) wearable fitness devices (e.g. Fitbit, Jawbone Up, smartwatches with fitness tracking (e.g. Apple iWatch, etc.)); and ii) mobile and desktop devices executing diet and fitness applications (“apps”) (e.g. MyFitnessPal, Lose It, etc.). Wearable fitness devices provide automatic sensor-based tracking of general physical activities, such as walking or movement. Tens of millions of wearable fitness devices have been sold and the product segment is rapidly growing. Wearable fitness devices may be in the form of, or integrated with, wrist-secured bands, smartwatches or clothes attachable/embedded devices.

The diet and fitness tracking apps market is saturated with hundreds of apps, which all address the problem of tracking diet and fitness data in a very inefficient way. For diet tracking, these apps require their users to execute a lengthy, tedious multi-step process in which users must: i) select breakfast, lunch, dinner or snack for meal placement-step submission; ii) type in the food name; iii) search for the food; iv) select the appropriate food from a long list of displayed options; v) confirm or edit the appropriate food quantity; and then repeat these steps for every food in the meal to be tracked. For exercise tracking, these apps also require their users to execute a similar lengthy, tedious multi-step process in which users must: i) select cardiovascular or strength training for exercise classification; ii) type the exercise name; iii) search for the exercise; iv) select the exercise from a list of displayed options; v) enter the quantity amount and units of the exercise done; and then repeat the foregoing steps for all exercises within a workout.

Wearable fitness devices were innovative products upon their first arrival to the market; and they provide a significantly more efficient method for tracking general exercise activity than that which is provided by the known conventional fitness apps. However, while wearable fitness devices are indeed very efficient for simple exercise tracking (e.g., how many steps did you walk, what distance did you walk, how many calories did you burn, etc.), they are deficient in other important ways.

One deficiency with known wearable fitness devices is that they do not offer any diet tracking capability. Users of wearable fitness devices must rely on a separate diet app or other approach for their diet tracking needs. Diet tracking is invaluable to any weight loss program as it is the method of determining the number of calories consumed by an individual. An individual striving to lose weight must consume fewer calories than the number of calories burned; therefore, one cannot reasonably manage a weight loss program without diet tracking.

Another deficiency in wearable fitness devices is that they are not capable of providing comprehensive tracking of specific exercise types. For example, if a user wants to track specific exercises (e.g., crunches, yoga, bench press, elliptical machine, P90x, etc.) and comprehensive quantities (e.g., 3 sets of 10 reps with 100 lbs, 4 sets of 45 seconds, etc.) he cannot do this using known wearable fitness devices, but must use a fitness tracking app to do so.

Currently known wearable fitness devices (e.g. Fitbit, Jawbone Up, smartwatches with fitness tracking (e.g. Apple iWatch, etc.)) are not able to provide either diet tracking capability or comprehensive exercise tracking capability as are devices in accordance with the invention, because known wearable devices are unable to receive and process the comprehensive and broad range of input data necessary.

In order for such wearable fitness devices to be able to eliminate the aforementioned deficiencies they would need to have a display screen roughly the size of a smartphone sized display screen. However, disregarding the impracticality of this, if these wearable fitness devices did have such a smartphone sized display screen the diet tracking and comprehensive exercise tracking capability would be extremely inefficient and time consuming for the user as it would use the same multi-step process used by diet and fitness tracking apps.

To illustrate how tedious such a multi-step process would be for a user of such a conventional wearable fitness device that had a smartphone sized display screen, we only need to contrast its user information submission requirements with the one-submission capability of the invention. A user tracking a four food meal with such a device would be required to make no less than twelve information submissions. For each food in a meal, submissions would include the following: i) select and submit breakfast, lunch, dinner or snack for meal placement of such food; ii) type in and submit the food name; iii) select and submit the appropriate food from a long list of displayed options; and iv) confirm or edit the food quantity and submit it. For exercise tracking, similar multi-step user information submission requirements would be necessary as users would have to do the following for each exercise in a workout: i) select and submit cardiovascular or strength training for exercise classification; ii) type and submit the exercise name; iii) select and submit the exercise from a list of options; and iv) enter the quantity amount and unit of the exercise done and submit.

It is desirable to provide a wearable diet and exercise tracking device that addresses the foregoing and other problems with known approaches, and it is to these ends that the present invention is directed.

### SUMMARY OF THE INVENTION

The invention affords a wearable diet and exercise tracking device that has one-submission tracking capability. One-submission tracking capability of a wearable diet and exercise tracking device in accordance with the invention enables a user of such device to track (log) data related to a discrete incidence of food consumption or physical activity such as food eaten and/or exercises performed, including the associated food(s) and/or exercise(s) input quantity(ies) (e.g., 1 cup, 2 sets of 25 repetitions, etc.), as well as to automatically associate with this data and track information on the related calories and nutrients and/or calories burned, upon a single submission (input) into such device of voice information by the user speaking describing the particulars of such food consumption or physical activity without further action by the user. The submission of voice information by a user in accordance with the invention may comprise naturally spoken, conversational speech and require no adherence by the user to grammatical or other rules of speech. A single user information submission into the wearable diet and exercise tracking device may comprise the process of a user entering audio information by speaking into a microphone of such device and saying the food(s) eaten and/or exercise(s) performed (and related quantity(ies)) with respect to a discrete incidence of food consumption or physical activity, respectively, and then tapping a display screen or pressing a button to submit (input) such information for tracking. Such device may then run its processes and automatically track such food(s) and/or exercise(s), food and/or exercise quantity(ies), and associate with the tracked data the corresponding calories and nutrients and/or calories burned; and this information may be reported back to a user of such device via a device display.

In one aspect, the invention affords a wearable diet and exercise tracking device that may be worn on the body of a user, or attached to or carried in clothing or associate carry bags of the user that: i) enables diet tracking directly via the device; ii) enables comprehensive particularized exercise tracking directly via the device, and the capture of significantly more specific exercise-related information than that which is afforded by the currently available wearable fitness devices; and iii) provide fast and efficient diet and exercise data input and tracking. Embodiments of wearable devices in accordance with the invention may be in the form of, or integrated with, wrist-secured bands, smartwatches, clothes and fitness gear attachable/embedded devices and other portable and/or wearable enclosures.

In other aspects, the invention affords i) one-submission tracking capability; ii) the automation of a complete diet tracking process; iii) the automation of a complete exercise tracking process; iv) the use of natural language processing with comprehensive text parsing and text cleaning methods; v) machine learning with large, real-time user data sets; vi) text aliasing logic and data that identifies and replaces incorrect text with aliased text that is more correct and appropriate (e.g., “oaks”=“oats”; “three”=“3”; etc.); and vii) quantity exceptions logic and data (e.g., 7 Eleven, 12 inch, P90X, etc.).

Wearable devices in accordance with the invention do not require features that are required by conventional devices, such as the following: i) an attached physical keyboard or touch screen keyboard; and/or ii) a large touch screen display that would be big enough to display necessary features and/or data, including: a) a usable touch screen keyboard, if included with such device; b) a search field large enough to fit multi-word food and/or exercise names; c) extensive lists of foods and exercises; d) adjustable lists of food and exercise units (e.g., ounces, cups, tbsp., lbs, minutes, etc.); e) data entry areas for numeric quantities; f) adjustable lists of meal types or exercise types; and g) comprehensive exercise quantity data (e.g., 6 sets of a strength training exercise of differing weights and repetitions). If a conventional wearable fitness device were to be able to provide the aforementioned features provided by the invention, the known device would need to have a screen display roughly the size of a smartphone screen display which would be completely impractical for a wearable device, and it still would only be able to use the same lengthy and tedious multi-step diet and exercise tracking experience which is provided by the current diet and fitness apps.

Currently known wearable fitness devices (e.g., Fitbit, Jawbone Up, smartwatches with fitness tracking (e.g., Apple iWatch, etc.)) are incapable of performing the foregoing processes that are performed by devices of the invention.

The figures and detailed description presented herein below show and describe methods, algorithms and processes of preferred embodiments of the invention.

### BRIEF DESCRIPTION OF THE DRAWINGS

In the course of the detailed description below, reference will be made to the attached drawings. These drawings illustrate different objects, aspects and advantages of the present invention, and also include reference numbers designating structures, components and elements present in the various embodiments illustrated. It is understood that various combinations of the structures, components and/or elements other than those specifically shown are also contemplated and are within the scope of the present invention.

Moreover, there are a number of different embodiments of wearable one-submission input tracking devices described and illustrated herein. The present invention is neither limited to any single aspect and/or embodiment, nor to any combinations and/or permutations of such aspects and/or embodiments. Moreover, each of the various aspects of the present invention, and/or embodiments thereof, may be employed alone or in combination with one or more of the other aspects and/or embodiments. For the sake of brevity, not all of the possible permutations and combinations are discussed and/or illustrated separately herein.

FIG. 1 shows three different embodiments of a wearable diet and exercise tracking device in accordance with the invention;

FIG. 2 is a block diagram illustrating a hardware architecture and exemplary components of an embodiment of a wearable diet and exercise tracking device such as shown in FIG. 1;

FIG. 3 is a flow diagram giving an overview of a tracking process that may be performed by an embodiment of a wearable diet and exercise tracking device such as shown in FIG. 2;

FIG. 4 is a flow diagram illustrating in more detail a voice transcription process, an automatic diet tracking process, and an automatic exercise tracking process shown in FIG. 3;

FIG. 5a is a flow diagram showing first steps performed by an embodiment of an automatic diet tracking system and an automatic application-based exercise tracking system in accordance with the invention; and

FIG. 5b is a continuation of the flow diagram in FIG. 5a that shows additional steps performed by an automatic diet tracking system and the automatic application-based exercise tracking system.

### DETAILED DESCRIPTION OF PREFERRED EMBODIMENTS

As will be described, a user of a wearable diet and exercise tracking device in accordance with the invention merely has to speak to enter data into the wearable diet and exercise tracking device as to what she ate and/or the exercise(s) she performed, and the device will automatically track the food(s) eaten, food numeric quantities and quantity units (e.g., 1 cup, 4 ounces, etc.) and the related calorie and nutrient data, and/or the exercise(s) performed, exercise numeric quantities and quantity units (e.g., 3 sets of 10 repetitions of 100 lbs., 2.75 miles, etc.) and the related calories burned data. Further, the tracked diet and exercise information is associated with the applicable parsed text segment that is derived from the conversion (transcription) of a user's voice input into the device into digital text form and subsequent text parsing.

A wearable diet and exercise tracking device of the invention has many features and functions that enable it to fill the deficiency voids in the currently known wearable fitness devices (e.g. Fitbit, Jawbone Up, smartwatches with fitness tracking (e.g. Apple iWatch, etc.)). These deficiencies include: i) the complete absence of diet tracking directly on such conventional devices; and ii) the inability to provide any comprehensive exercise tracking directly on such device. In contrast, in a preferred embodiment the invention provides diet tracking and comprehensive exercise tracking directly on a wearable diet and exercise tracking device.

Importantly, in a preferred embodiment, the invention may enable one-submission tracking capability which, as described above, merely requires a user to input a single information submission (which may be a single user comprehensive voice statement input into such device) for diet tracking and/or comprehensive exercise tracking. This enables input data for tracking without the need for a keyboard or a very large touch screen display. As a result, in a preferred embodiment, a wearable diet and exercise tracking device of the invention can receive directly and track comprehensive diet and/or exercise information.

As mentioned above, and as will be described below, the invention may advantageously provide: i) one-submission tracking capability; ii) the automation of a complete diet tracking process; iii) the automation of a complete exercise tracking process; iv) natural language processing with comprehensive text parsing and cleaning methods; v) machine learning with large, real-time user data sets; vi) text aliasing logic and data that replaces certain incorrect text with aliased text that s appropriately corrected (e.g., “oaks”=“oats”; “three”=“3”, etc.); and vii) quantity exceptions logic and data that correctly differentiates between numerical quantities and non-quantity numerical data (e.g., 7 Eleven, 12 inch, P90X, etc.). The following paragraphs of this description and the associated drawings will describe and illustrate these features and methods generally. More detailed descriptions are provided the above-referenced patent application Ser. No. 15/041,780 and patent application Ser. No. 15/161,588.

As shown and described herein, a wearable diet and exercise tracking device of the invention may receive user-submitted voice input information via a microphone as speech describing food(s) eaten and/or exercise(s) completed. A voice transcription component may process the user voice input audio data and produce one or more segments of parsed text comprising diet-related and/or exercise-related terms if a locally stored match for such user audio input data exists. The parsed text segment(s) may then be passed to an automatic diet tracking component for diet tracking and/or to an automatic exercise tracking component for exercise tracking. These tracking components may deliver: i) a food or exercise match(es) for each such parsed text segment; ii) associated food and/or exercise numeric quantity(ies) and quantity unit(s); and iii) the corresponding data as to calories and nutrient and/or calories burned data to output components of the device, such as a display and a speaker for presentation to the user. Matching input to locally stored audio and parsed text affords a faster presentation of the diet or exercise information to the user.

If the voice transcription component does not find a match locally for such user voice input audio data, or if the automatic diet tracking component or the automatic exercise tracking component does not find a match for such parsed text segment(s), then such audio data may be transmitted via a communications port on such device to an external voice transcription system residing on external network-based computer servers that have greater processing capability and access to a larger database of text for possible matches. The voice transcription system may process such audio data and convert (transcribe) such audio data into transcribed text that may be delivered to an automatic diet tracking system and an automatic application-based exercise tracking system, which may use one or more food and exercise text parsing algorithms to parse the transcribed text into one or more segments of parsed text.

The automatic food or exercise quantity and unit tracking method and related algorithms may then strip any numeric quantity(ies) from the parsed text and use a multi-path unit database search to find any food and/or exercise quantity unit(s) (e.g., cups, ounces, miles, repetitions, etc.) in such parsed text, as described in the above-referenced patent applications. The remaining parsed text may be sent to a food or exercise text cleaning algorithm, which may deliver parsed and cleaned text into an automatic food or exercise tracking process, where any quantity units found may also have been delivered for use therein. Such automatic food or exercise tracking processes may utilize food or exercise text match and text scoring algorithms, which may include user data history lookups, entire user population data history lookups, search string modifications, database searches and search scoring and various other machine learning techniques, to identify the food(s) and/or exercise(s) to track for such parsed and cleaned text, and may send such identified food(s) and/or exercise(s) to an automatic calories and nutrient and/or calories burned tracking process as described in the referenced patent applications for assignment of applicable calories and nutrient and/or calories burned data.

If the parsed text does not contain a quantity unit, e.g., “cup”, “ounces”, etc., then a user data history lookup followed by an entire user population data history lookup may be performed to identify previous quantity unit data associated with such food(s) and/or exercise(s) to determine what unit(s) should be tracked. If such parsed text does not contain a numeric quantity a user data history and entire user population data history lookup may be done to assign a most-frequently associated numeric quantity to each such food(s) and/or exercise(s) quantity unit(s).

The food(s) and/or exercise(s), and the related numeric quantity(ies), quantity unit(s) and calories and nutrient and/or calories burned data, may then be delivered to a multi-food and exercise administration component, which may organize such information and its related parsed text and parsed and cleaned text for transmission to a communications port on such wearable diet and exercise tracking device, where it may be delivered to the device output components, such as a display and/or a speaker, for presentation to such user.

The aforementioned innovative processes afforded by the invention may provide automatic diet and exercise tracking for all diet and/or exercise information submissions, including submissions that do not include a numeric quantity and/or a quantity unit. This enables the previously described one-submission tracking capability, and results in a superior tracking experience over the current art in wearable fitness device and app-based diet and exercise tracking. Advantageously, users need only a single information input submission for complete automatic diet and/or exercise tracking of one or more foods and/or exercises.

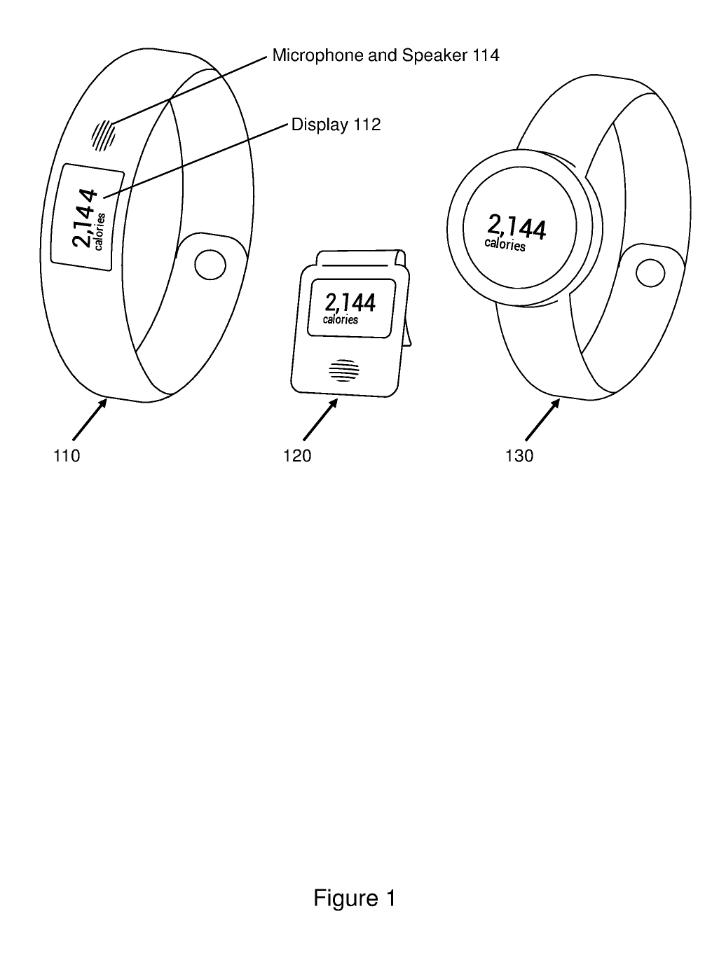

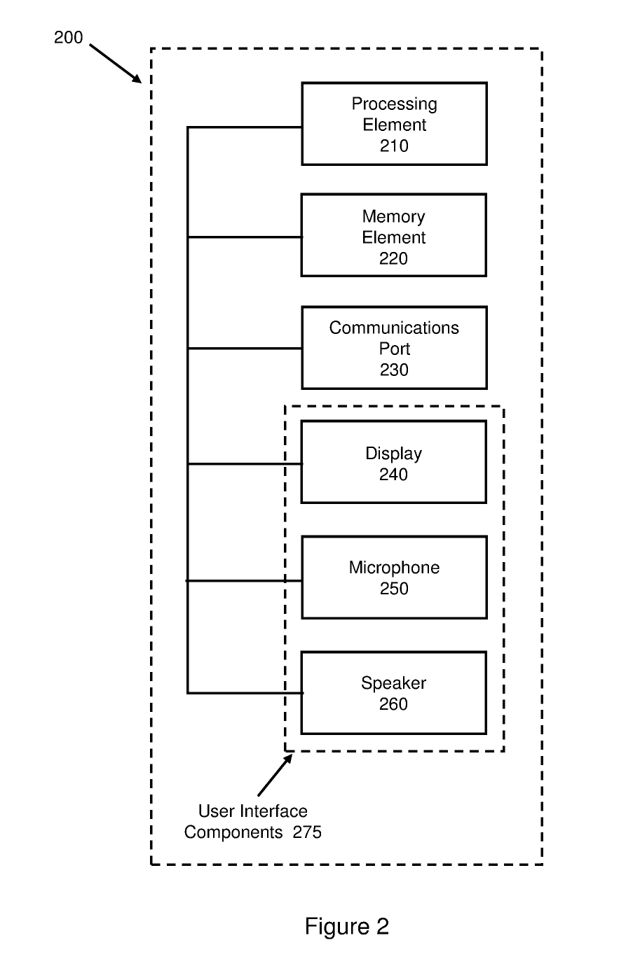

Referring to the drawings, FIG. 1 illustrates three different embodiments of a diet and exercise tracking device in accordance with the invention. As shown, the device may be wearable, such as a wearable wrist-secured band 110, clothes and fitness gear attachable 120 or a smartwatch 130. The tracking device may also be a one that is carried in a pocket or a bag, embedded in clothing or fitness gear or contained in other wearable enclosures. As will be described below, FIG. 2 illustrates a preferred hardware architecture and components of these devices. As shown, the devices may include a processing element 210, a memory 220 for storing information and data, including: i) the executable instructions; ii) audio data; iii) parsed text; and iv) food and exercise related data, as more fully described herein below, a communications port 230 for wireless transmitting data to and receiving of data from external computer servers, and user interface components 275, including a display 240, a microphone 250 and a speaker 260. Corresponding user interface components shown in FIG. 1 are display 112 and microphone/speaker 114 (the smartwatch 130 of FIG. 1 may have a microphone and speaker that are not shown).

Importantly, as shown in FIG. 1, embodiments of the wearable diet and exercise tracking device may have only a small display 112; they do not require a large display as would be the case of what would be required by a wearable fitness device (e.g., Fitbit, iWatch, etc.) to accommodate a touch screen user interface to provide diet tracking and comprehensive exercise tracking. In fact, one embodiment of the invention may be one that provides diet tracking and comprehensive exercise tracking directly through such device without any display at all, as it may use a physical button for user information submission and the speaker 114 for reporting tracking information to such user. Similarly, a speaker 114 may be omitted, as user results may be reported via the display 112.

The preferred embodiments of the invention illustrated in FIG. 1 also do not have any attached physical keyboard or touch screen keyboard as a keyboard is not required for a wearable diet and exercise tracking device to provide diet tracking and comprehensive exercise tracking directly through such device. This contrasts the current art in diet and fitness tracking apps which require a keyboard in order to work.

This capability of functioning with only a small display or no display at all and no keyboard results from the following features and methods of the invention: i) one-submission tracking capability; ii) the automation of the complete diet tracking process; and iii) the automation of the complete exercise tracking process. The aforementioned features and methods include the following: i) the use of natural language processing with comprehensive text parsing and cleaning methods; ii) machine learning with large, real-time user data sets; iii) text aliasing logic and data that replaces certain text with aliased text that is appropriate (e.g., “oaks”=“oats”; “three”=“3”, etc.); and vii) quantity exceptions logic and data (e 7 Eleven, 12 inch, P90X, etc.).

FIG. 2 is a block diagram showing a hardware architecture and components that may be used in a wearable diet and exercise tracking device 200, such as the embodiments shown in FIG. 1. Device 200 may comprise a processing element 210, which may be a microprocessor, and executable instructions embodied in computer readable media (not shown explicitly) for controlling the microprocessor to perform the operations described herein, and may have a memory element 220 which may store information and data, including: i) such executable instructions; ii) audio data; iii) parsed text; and iv) food and exercise related data, as more fully described herein below. Such device may have a communications port 230 which may send and receive user voice input audio data and food and exercise related data via WIFI, GSM, CDMA, Bluetooth or other communications technologies to related networks. Such data may be sent to and received from Internet-based computer servers hosting: i) an automatic diet tracking system, described herein and more fully detailed in the above-referenced patent application Ser. No. 15/041,780; and/or ii) an automatic application-based exercise tracking system, described herein and more fully detailed in the above-referenced patent application Ser. No. 15/161,588; and iii) a voice transcription system, which all may be integrated with a wearable diet and exercise tracking device. The device may also include a display 240, microphone 250 and speaker 260 (that may be combined), which collectively are user interface components 275. The display 240 may enable a user to: i) invoke the microphone 250; ii) submit voice input audio data; and iii) view the reporting of food and exercise tracking related information, including foods consumed and/or exercises performed and associated food and/or exercise numeric quantity(ies) and unit(s) and the related calories and nutrient and/or calories burned data. The microphone 250 may enable the recording of user voice input audio data, and the speaker 260 may also enable the reporting of food and exercise tracking related information described above to the user.

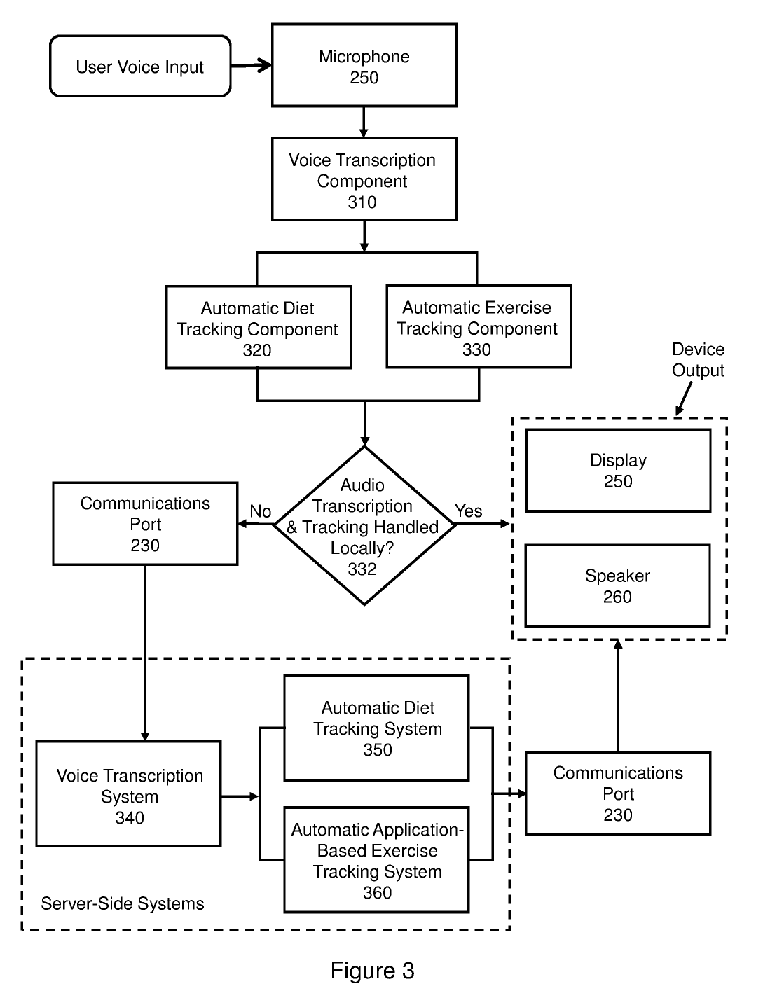

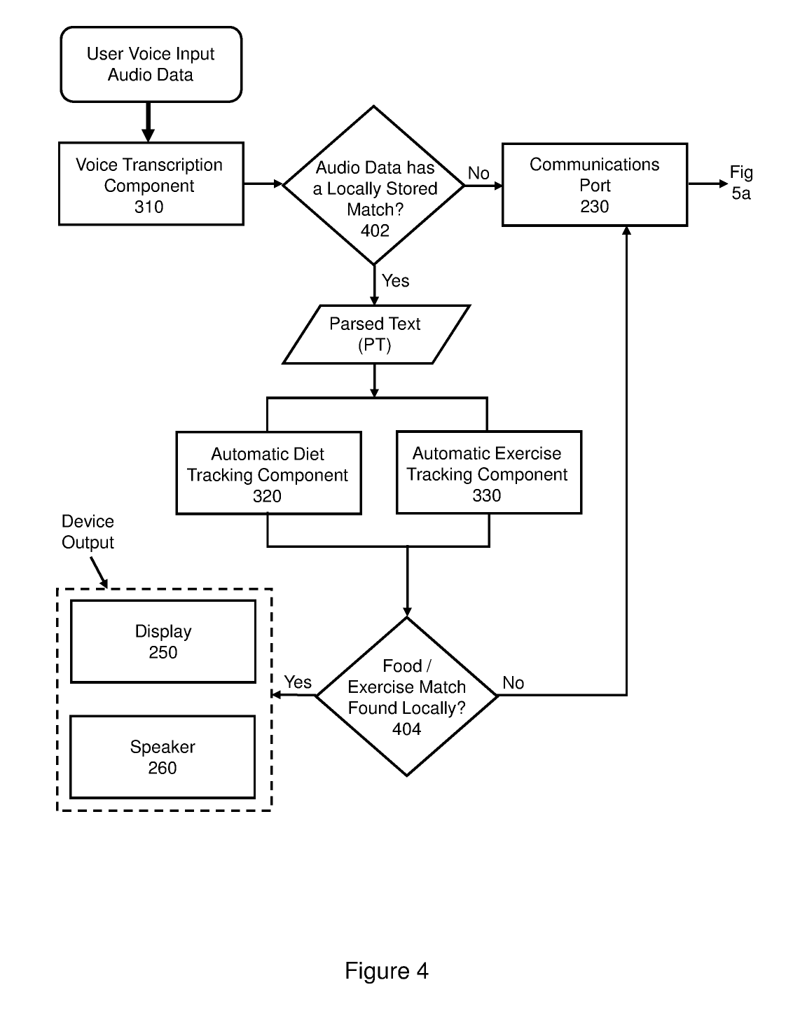

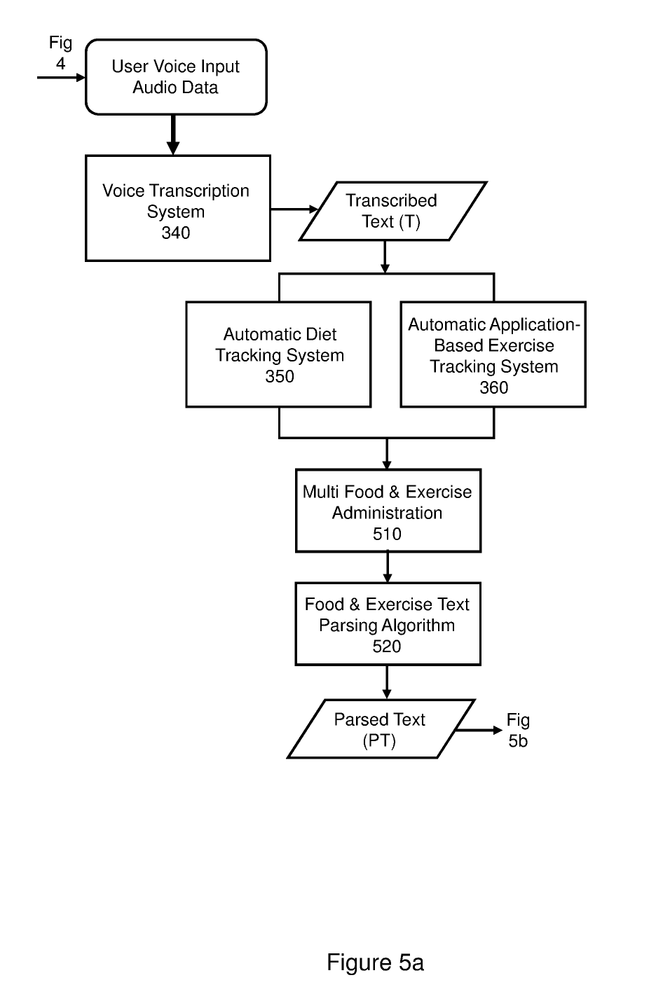

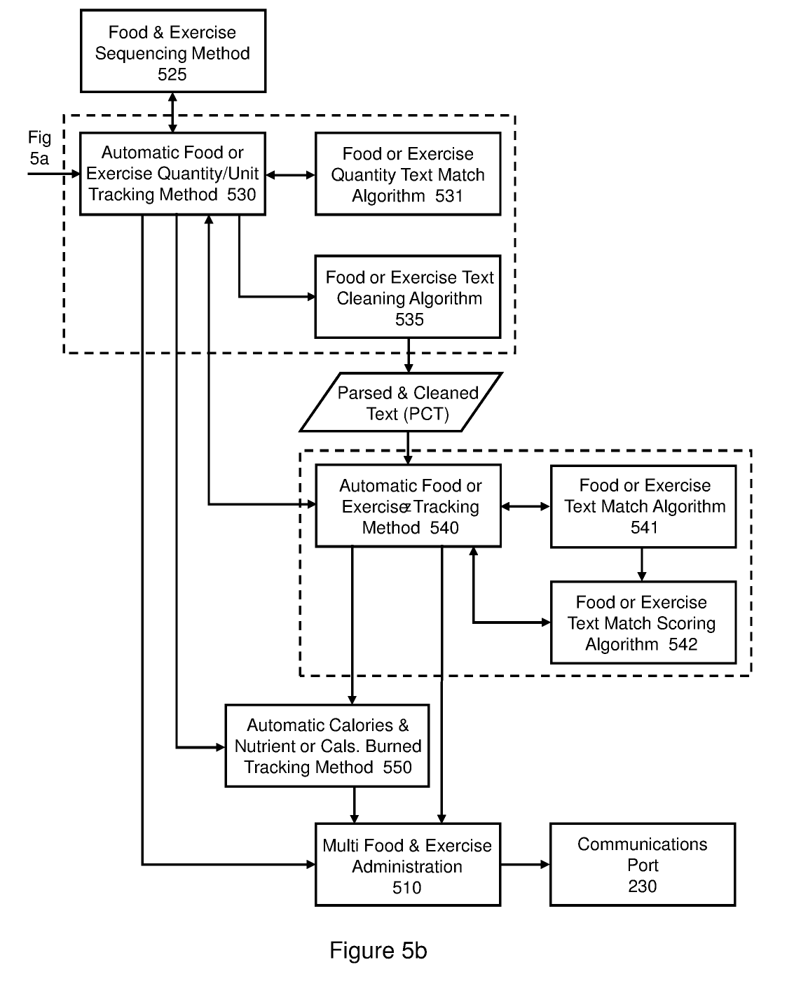

FIG. 3 is a flow diagram showing an overview of the general processing steps performed by a preferred embodiment of a wearable diet and exercise tracking device 200 shown in FIG. 2. The embodiment of the wearable diet and exercise tracking device shown may receive voice input from a user and may: i) convert (transcribe) such voice input to text; ii) track one or more foods and/or exercises, and associated numeric quantity(ies) and unit(s) and nutrient and/or calories burned data; and iii) return such diet and/or exercise tracking information to the user via a device output. As shown in FIG. 3, a user may submit audio data as voice input into the microphone 250 of a wearable diet and exercise tracking device 200, which captures the audio data and such audio data may then be delivered into a voice transcription component 310 on the device. The voice transcription component 310 may perform calculations on the input voice audio data to enable the determination of whether a match for such audio data is stored locally in the memory element 220 of such device (i.e., determine if a user has submitted the same/similar voice input audio data previously). If a match does exist, such component delivers a matching parsed text (PT) segment(s) that is associated with such audio data into an automatic diet tracking component 320 and/or into an automatic exercise tracking component 330, as appropriate. Parsed text (PT) may be originally created for user submitted voice input audio data by a food and exercise text parsing algorithm 520, shown in FIG. 5a, which receives transcribed text (T) from the transcription of such audio data to text by the voice transcription system 340, and then parses the transcribed text (T) into segments of parsed text (PT). An automatic diet tracking component 320 and an automatic exercise tracking component 330 may then determine if a match for each such segment of parsed text (PT) is stored locally in the memory element 220 of such device, and if a match does exist such component(s) may track an associated food(s) and/or exercise(s) and related food and/or exercise numeric quantity(ies) and quantity unit(s) and related calories and nutrient and/or calories burned data. As shown in FIG. 3, the process, at 332, consolidates the aforementioned processes into one If-Then decision statement. If such audio data transcription and food and/or exercise tracking is handled locally on the device at 332, then such parsed text (PT) and associated food(s) and/or exercise(s), numeric quantity(ies) and quantity unit(s) and related calories and nutrient and/or calories burned data may be reported to the user via the device output components, such as a display 250 and speaker 260 (such as shown in FIG. 3 as is more fully detailed in FIG. 4).

Else, FIG. 3 shows that if such audio data transcription and food and/or exercise tracking is not handled locally on the device at 332, then the user voice input audio data may be transmitted externally via the communications port 230 to an external network, Internet-based for instance, computer server-side system, and may enter the voice transcription system 340 which may generate transcribed text (T). Whether processing is handled locally or externally may depend upon whether a match is found locally, and how much data storage capacity the device has. Limitations in the amount of data that can be stored locally in the memory element 220 of the wearable diet and exercise tracking device may make it necessary to utilize external systems such as 340, 350, and 360 of FIG. 3. Therefore, the components 310, 320, and 330 may utilize logic rules, including ranking of audio data priority and related tracked food and exercise data using; i) user history data, entire user population history data and recently tracked weightings, in the executable instructions governing what audio data, parsed text (PT) and related food and exercise data to store locally in the memory element 220 of such device.

Continuing on FIG. 3, transcribed text (T) may then enter an automatic diet tracking system 350 and an automatic application-based exercise tracking system 360 which may use a food and exercise text parsing algorithm 520, shown in FIG. 5a, to parse the transcribed text (T) into parsed text (PT), and may use a food or exercise text cleaning algorithm 535, shown in FIG. 5b, to clean the parsed text (PT) by removing words, connected spaces, and punctuation that are not used to identify food(s) and exercise(s) to produce parsed cleaned text (PCT). An automatic diet tracking system 350 and an automatic application-based exercise tracking system 360, using sequencing rules then use such parsed text (PT) and such parsed cleaned text (PCT) to produce the food(s) and/or exercise(s) and food and/or exercise numeric quantity(ies) and quantity unit(s) and related calories and nutrient and/or calories burned data to be tracked, and such information may then be delivered back to the device output components, a display 250 and a speaker 260, via the communications port 230 (such aforementioned process in this FIG. 3 is more fully described in FIG. 5a and FIG. 5b).

FIG. 4 is a flow diagram showing additional processing performed by an embodiment of a voice transcription component 310, an automatic diet tracking component 320 and an automatic exercise tracking component 330 shown in FIG. 3, which components and processes may be embodied in the wearable diet and exercise tracking device to provide diet and exercise tracking using audio data, parsed text (PT) and food and exercise data that may be stored locally in the memory element 220 of such device. The invention utilizes components 310, 320 and 330 and the locally stored data to maximize the diet and exercise tracking speed and efficiency of such device. As shown in FIG. 4, audio data from a user voice input into a microphone 250 may be processed by a voice transcription component 310 and a determination may be made at 402 whether a locally stored match for such audio data exists on such wearable diet and exercise tracking device. The audio data match may be determined by a correlation algorithm, for instance, that compares the new audio data received with locally stored segments of audio data or the locally stored results of calculations on previously input audio data, and if there is a sufficiently high positive correlation (e.g., above a threshold of 90%, 95%, etc.—levels may be adjusted to optimize performance) found between the new audio data and a locally stored segment of audio data or the locally stored results of calculations on previously input audio data a match is recognized (if more than one, the highest correlating segment is used).

If in FIG. 4 it is determined at 402 that an audio data match exists, then the voice transcription component 310 may produce parsed text (PT) associated with such matching audio data segment. Such parsed text (PT) may then be passed into an automatic diet tracking component 320 and an automatic exercise tracking component 330, as appropriate, which then may determine at 404 if a locally stored food and/or exercise match(es) and associated numeric quantity(ies) and quantity unit(s) for such parsed text (PT) exists on such wearable diet and exercise tracking device. If it is determined at 404 that a match(es) exists, the match(es) may be used to deliver food(s) and/or exercise(s) and the associated numeric quantity(ies) and quantity unit(s) and related calories and nutrient and/or calories burned data to the device output components, e.g., display 250 and speaker 260, for presentation to the user of such device. The output may be organized based on whether it was generated from the automatic diet tracking component 320 and the automatic exercise tracking component 330 (if more than one match is found, the most recently tracked match shall be tracked). If it is determined at 404 that no match exists, then the audio data may be transmitted via the communication port 230 to a voice transcription system 340 residing on the external network-based computer servers.

FIG. 5a is a flow diagram that is a continuation of the process shown in the flow diagram of FIG. 4. It shows the first steps that may be performed by an automatic diet tracking system 350 and an automatic application-based exercise tracking system 360 shown in the FIG. 3. FIG. 5a shows such user voice input audio data enters a voice transcription system 340, which converts (transcribes) such audio data into transcribed text (T). An automatic diet tracking system 350 (fully detailed in the above-referenced patent application Ser. No. 15/041,780) is a system that receives transcribed text (T) and utilizes many methods and algorithms to produce the associated diet tracking information, including food name(s), food numeric quantity(ies) (e.g., 1, 2, 3, etc.), food quantity unit(s) (e.g., cup, ounce, etc.) and the related calories and nutrient data. An automatic application-based exercise tracking system 360 (fully detailed in the above-referenced patent application Ser. No. 15/161,588) receives transcribed text (T) and utilizes the described methods and algorithms to produce the associated exercise tracking information, including exercise name(s), exercise time, distance and/or resistance numeric quantity(ies) (e.g., 2, 10, 35, etc.), exercise time, distance and/or resistance quantity unit(s) (e.g., miles, minutes, sets and repetitions, etc.) and the related calories burned data. As described above, such automatic diet tracking system 350 and automatic application-based exercise tracking system 360 reside externally from such device on Internet-based computer servers.

FIG. 5a shows transcribed text (T) may enter an automatic diet tracking system 350 and an automatic application-based exercise tracking system 360 which may first utilize: i) a multi food and exercise administration component 510 to store such transcribed text (T) for subsequent association with: a) food and/or exercise tracking data; b) parsed text (PT); and c) parsed cleaned text (PCT); and ii) a food and exercise text parsing algorithm 520 to parse the transcribed text (T) and produce parsed text (PT).

FIG. 5b illustrates additional process of FIG. 5a, and shows further steps that may be performed by the automatic diet tracking system 350 and the automatic application-based exercise tracking system 360. A food and exercise sequencing method 525 may provide sequencing logic to determine when the various methods of such automatic diet tracking system 350 and such automatic application-based exercise tracking system 360 may be invoked in order to provide the most efficient diet and/or exercise tracking process. Food and exercise sequencing method 525 may operate to first determine if a segment of parsed text (PT) contains a food or exercise quantity unit(s), or both, by utilizing a food quantity text match algorithm or an exercise quantity text match algorithm (both algorithms are jointly shown at 531 in FIG. 5b), in that order. If only a food unit(s) is found, then the parsed text (PT) may be processed fully through the methods of the automatic diet tracking system 350; if only an exercise unit(s) is found, then the parsed text (PT) may be processed fully through the methods of such automatic application-based exercise tracking system 360. If both a food and an exercise unit(s) are found, then such parsed text (PT) may be first processed fully through the methods of such automatic application-based exercise tracking system 360 and then through the methods of such automatic diet tracking system 350. Else, if no units are found then such parsed text (PT) may be first processed fully through the methods of such automatic application-based exercise tracking system 360 and then through the methods of such automatic diet tracking system 350.

In FIG. 5b, for tracking a food(s), parsed text (PT) may enter into an automatic food quantity and unit tracking method 530 which utilizes a food quantity text match algorithm 531 that may: i) remove food numeric quantity (e.g., 1, 2, 3, etc.), if any, from the parsed text (PT); and ii) run a multi-path unit database search(es) on the parsed text (PT) to find a food quantity unit (e.g., cup, ounce, etc.). If a food unit(s) is found, it may be delivered along with any food numeric quantity(ies) to: i) the multi food and exercise administration component 510; ii) an automatic calories and nutrient tracking process 550; and iii) an automatic food tracking process 540 for storing and use therein. If the parsed text (PT) does not contain a food numeric quantity, the system may assume a predetermined quantity of one (1). The remaining parsed text (PT) may then be passed into a food text cleaning algorithm 535 which may clean the parsed text (PT) to produce parsed cleaned text (PCT) and deliver such parsed cleaned text (PCT) into an automatic food tracking method 540. An automatic food tracking method 540, which may utilize a food text match algorithm 541 and a food text match scoring algorithm 542, may produce the food (F) to be tracked by the system for each segment of parsed cleaned text (PCT) and then may pass such food (F) back to an automatic food quantity and unit tracking method 530 for use therein in completion of its processes. Each generated food (F) may then be passed to an automatic calories and nutrient tracking method 550 which may attach applicable nutrition data to each such food (F) and its related quantity(ies) and unit(s), and each food name and applicable nutrition data may be sent to a multi-food and exercise administration component 510, which may keep food name(s) and related data organized and properly associated with the proper segments of the parsed text (PT) for quantity(ies) and unit(s) and parsed cleaned text (PCT) for food name(s) for delivery back to the wearable diet and exercise tracking device, via the communications port 230 on such device, for presentation to the user via the device output components, the display 250 and speaker 260.

In FIG. 5b, for tracking an exercise(s), parsed text (PT) may enter into the automatic exercise quantity and unit tracking method 530 which utilizes the exercise quantity text match algorithm 531 that may: i) remove exercise time, distance and/or resistance numeric quantity(ies) (e.g., 2, 10, 35, etc.), if any, from the parsed text (PT); and ii) run a multi-path unit database search(es) on the parsed text (PT) to find an exercise time, distance and/or resistance quantity unit(s) (e.g. miles, minutes, sets and repetitions, etc.). If an exercise unit(s) is found, it may be delivered along with any exercise numeric quantity(ies) to: i) a multi food and exercise administration component 510; ii) an automatic calories burned tracking method 550; and iii) an automatic exercise tracking method 540 for storing and use therein. If the parsed text (PT) does not contain an exercise numeric quantity, the system may utilize user data history and/or entire user population data history lookups in assigning a most commonly associated exercise numeric quantity to each such exercise quantity unit. The remaining parsed text (PT) may then be passed into the exercise text cleaning algorithm 535 which may clean the parsed text (PT) to produce parsed cleaned text (PCT) and deliver such parsed cleaned text (PCT) into the automatic exercise tracking method 540. The automatic exercise tracking method 540 may utilize an exercise text match algorithm 541 and an exercise text match scoring algorithm 542 to determine the exercise (E) to be tracked by the system for each segment of parsed cleaned text (PCT), and then may pass such exercise (E) back to the automatic exercise quantity and unit tracking process 530 for use therein in completion of its tracking processes. Each generated exercise (E) may then be passed to an automatic calories burned tracking method 550 which may attach applicable calories burned data to each such exercise (E) and its related quantity(ies) and unit(s). Each exercise name and applicable calories burned data may be sent to the multi-food and exercise administration component 510, which may keep exercise name(s) and related data organized and properly associated with the proper segments of the parsed text (PT) for quantity(ies) and unit(s), and parsed cleaned text (PCT) for exercise name(s) for delivery back to such wearable diet and exercise tracking device, via the communications port 230 on such device, for presentation to such device user via the device output components.

Details of the processes and components of FIG. 5a and FIG. 5b, as well as the other processes shown and described herein may be found in the above-referenced patent applications.

While the above description has been with respect to particular embodiments, it will be appreciated that changes to these embodiments may be made without departing from the principles of the invention, the scope of which is presented in the attached claims.

1. A device adapted to be worn on or carried by a user for tracking diet and exercise information, comprising:
a microphone for receiving input voice information from the user of the device stating one or both of foods and corresponding food quantities consumed or exercises and corresponding exercise quantities performed;
a processor for receiving said input voice information;
a memory connected to said processor, the memory storing executable instructions for controlling the processor to match the input voice information from the user to stored input information and text that identifies one or both of said foods and food quantities or said exercises and exercise quantities;
said instructions controlling said processor to associate said input food and food quantity information with corresponding nutritional and calorie information, or to associate said input exercise and exercise quantity information with calories burned information, and to store said nutritional and calorie information and said exercise and exercise quantity information in said memory as tracked information;
the executable instructions controlling the processor to communicate the input voice information to an external system if no input voice information match is found in said memory; and
an output unit for reporting tracked information to a user.

2. The device of claim 1, wherein said device automatically associates said input voice information with said food and food quantity information and with corresponding calorie and nutritional information, and automatically associates said input voice information with said exercise and said exercise quantity information and with calories burned information.

3. The device of claim 1 further comprising a communications unit that communicates with said external system to send said input voice information and to receive externally stored information as to transcribed text, food and food quantity matches, exercise and exercise quantity matches and corresponding nutritional, calorie and calories burned information.

4. The device of claim 1, wherein said output unit comprises one or both of a display and a speaker on said device for providing displayed text and audio information to the user.

5. The device of claim 1, wherein said device is wearable as a band on the wrist of a user.

6. The device of claim 1, wherein said device is adapted to be carried by the user.

7. The device of claim 1, wherein said executable instructions control said processor to provide one-submission tracking of said input voice information input comprising a single information submission as a single user comprehensive voice statement of one or more foods and corresponding food quantity or quantities consumed or one or more exercises and corresponding exercise quantity or quantities performed.

8. The device of claim 1, wherein said device is controlled to track data related to a discrete incidence of food consumption or physical activity upon a single submission of input voice information by the user speaking describing the particulars of such food consumption or physical activity without further action by the user.

9. The device of claim 8, wherein said input voice information comprises naturally spoken, conversational speech requiring no adherence by the user to grammatical or other rules of speech.

10. A device adapted to be worn on or carried by a user for tracking diet and exercise information, comprising:
a microphone for receiving from the user of the device as a single submission input voice information by the user speaking describing food consumption or physical activity and corresponding food quantities consumed or exercises and corresponding exercise quantities performed;
a processor; and
a memory connected to said processor, the memory storing executable instructions for controlling the processor, said instructions controlling said processor to track data in response to a single submission of input voice information by the user speaking describing the particulars of such food consumption or physical activity without further action by the user.

11. The device of claim 10, wherein said device automatically associates said input voice information with said food and food quantity information and said food and food quantity information with corresponding calorie and nutritional information, and automatically associates said input voice information with said exercise and said exercise quantity information and said exercise and said exercise quantity information with calories burned information.

12. The device of claim 10, wherein said voice information comprises speech describing the particulars of such food consumption or physical activity as naturally spoken, conversational speech requiring no adherence by the user to grammatical or other rules of speech.
